(19) United States
(12) Patent Application Publication
(10) Pub. No.: US 2023/0271451 A1
(43) Pub. Date: Aug. 31, 2023

(54) SYSTEM FOR NON-PNEUMATIC SUPPORT OF A VEHICLE

(71) Applicant: The Goodyear Tire & Rubber Company, Akron, OH (US)

(72) Inventors: Babatunde Omogbolahan Agboola, Uniontown, OH (US); Cheng-Hsiung Lin, Hudson, OH (US)

(21) Appl. No.: 17/680,941

(22) Filed: Feb. 25, 2022

(51) Int. Cl. B60C 7/20; F16F 1/02; B60C 7/06

(52) U.S. Cl. CPC B60C 7/20; F16F 1/021; B60C 7/06; F16F 2224/0208; F16F 2234/00

(57) ABSTRACT

An assembly has a wheel and a nonpneumatic tire. The nonpneumatic tire includes a plurality of helical springs. Each helical spring includes a first end portion, a second end portion, and an arching middle portion. Each helical spring being is interlaced with at least one other helical spring thereby forming a laced toroidal structure extending about an entire circumference of the nonpneumatic tire. The toroidal structure supports an entire load placed on the nonpneumatic tire. The plurality of helical springs are constructed of a predetermined material that maintains strength and ductility down to 17 K.

### FIELD OF THE INVENTION

The present invention relates to a system for non-pneumatic support of a vehicle and, more specifically, to a non-pneumatic tire for extremely low temperature service.

### BACKGROUND OF THE INVENTION

The National Aeronautics and Space Administration (NASA) has developed surface vehicles to support long range lunar exploration, the development of a lunar outpost, and other planetary exploration. These vehicles are heavier and travel greater distances than the Lunar Roving Vehicle (LRV) developed for the Apollo program in the late 1960s. Consequently, new tires will be required to support up to ten times the weight, and last for up to one hundred times the travel distance, as compared to those used on the Apollo LRV, thereby requiring operational characteristics similar to passenger vehicles used on earth. However, conventional rubber pneumatic tires cannot function acceptably in space.

For example, rubber properties vary significantly between the cold temperatures experienced in shadow (down to 40 K) and the hot temperatures in sunlight (up to 400 K). Further, rubber degrades when exposed to direct solar radiation, without atmospheric protection. Finally, an air-filled tire is not permissible for manned lunar vehicles because of the possibility of a flat tire. To overcome these limitations, a tire design has been developed for the Apollo LRV and was successfully used on Apollo missions 15, 16, and 17. This non-pneumatic tire was woven from music wire, which was robust to lunar temperature variations and solar radiation, operated in vacuum, and did not require air for load support. This structure further functioned to contour to the lunar terrain, which facilitated traction and reduced vibration transfer to the Apollo LRV.

As stated above, because of the new weight and distance requirements for lunar vehicles, a tire with greater strength and durability was required. Further, it has been found that vehicles and tires on the moon may experience temperatures as low as 25 K. One conventional wheel and non-pneumatic tire assembly has a variable diameter which, in addition to changing its diameter, may also change its width, thereby increasing the area of the tire that engages the lunar surface. Thus, this non-pneumatic tire may be adjusted to increase a vehicle's performance according to the terrain over which it is traveling. This tire/wheel may have arching members with first and second ends connecting a wheel hub. The arching members may be interlaced helical springs forming a partially compliant cage. The arching members may extend outwardly in an arc between the first and second ends. The arching members form a plurality of flexible hoops spaced circumferentially around the hub and extending radially outward from the hub. For example, the conventional cage may include thirty-eight equally spaced radially extending hoops that arch between axially outer rims of a hub. The hoops may be made of helical steel springs cut to a desired length and threaded through each adjacent spring. The conventional hub may be expanded/contracted axially for varying the diameter of the tire/wheel.

Thus, such a conventional non-pneumatic tire/wheel includes a plurality of helical springs. Each helical spring includes a first end portion, a second end portion, and an arching middle portion interconnecting the first end portion and the second end portion. Each helical spring is interwoven, or interlaced, with at least one other helical spring of the plurality thereby forming a woven toroidal structure extending about an entire circumference of the non-pneumatic tire/wheel. A subset of helical springs may be secured to a first annular rim of a wheel and/or a second annular rim of the wheel. A wheel with an annular rim at each axial side of the tire may secure the tire to the wheel. Thus, as compared to structures of conventional pneumatic tires, the woven/laced toroidal structure of interwoven helical springs may define a first ply for the non-pneumatic tire. A second ply may radially overlap the first ply. Such a second ply may comprise the same interwoven toroidal structure as the first ply. The conventional steel tire/wheel has now been found to experience temperatures as low as 25 K on the moon. Steel becomes weak and brittle under such conditions. As a result, an improved non-pneumatic tire for use on the moon is desirable.

### Definitions

“Apex” means an elastomeric filler located radially above the bead core and between the plies and the turnup ply.

“Annular” means formed like a ring.

“Aspect ratio” means the ratio of its section height to its section width. [0025] “Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load.

“Gauge” refers generally to a measurement, and specifically to a thickness measurement.

“Harshness” means the amount of disturbance transmitted by a tire when it passes over minor, but continuous, road irregularities.

“High tensile steel (HT)” means a carbon steel with a tensile strength of at least 3400 MPa at 0.20 mm filament diameter.

“Hysteresis” means a retardation of the effect when forces acting upon a body are changed.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Mega tensile steel (MT)” means a carbon steel with a tensile strength of at least 4500 MPa at 0.20 mm filament diameter.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Ply” means a cord-reinforced layer of rubber-coated radially deployed or otherwise parallel cords.

“Pneumatic tire” means a laminated mechanical device of generally toroidal shape (usually an open-torus) having beads and a tread and made of rubber, chemicals, fabric, steel, and/or other materials. When mounted on the wheel of a vehicle, the pneumatic tire, through its tread, provides traction and contains a fluid that sustains the vehicle load.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rim” means a support for a tire or a tire and tube assembly upon which the tire is secured.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Spring rate” means the stiffness of a tire or spring expressed as the slope of a load defection curve.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); (5) a narrow strip of material with or without twist.

### SUMMARY OF INVENTION

An assembly in accordance with the present invention has a wheel and a nonpneumatic tire. The nonpneumatic tire includes a plurality of helical springs. Each helical spring includes a first end portion, a second end portion, and an arching middle portion. Each helical spring is interlaced with at least one other helical spring thereby forming a laced toroidal structure extending about an entire circumference of the nonpneumatic tire. The toroidal structure supports an entire load placed on the nonpneumatic tire. The first end portions of the helical springs are directly secured to a first annular structure of the wheel and the second end portions of the helical springs are directly secured to a second annular structure of the wheel. The first end portion of each of the plurality of helical springs is oriented coaxially with the second end portion of each of the plurality of helical springs. The plurality of helical springs are constructed of a predetermined material that maintains strength and ductility down to 17 K.

According to another aspect of the assembly, the predetermined material is 304ELC stainless steel.

According to still another aspect of the assembly, the predetermined material is 310 Low-C stainless steel.

According to yet another aspect of the assembly, the predetermined material is 2024-T4 aluminum.

According to still another aspect of the assembly, the predetermined material is 6061-T6 aluminum.

According to yet another aspect of the assembly, the predetermined material is 2219-T87 aluminum.

According to still another aspect of the assembly, the predetermined material is 5052-H38 aluminum.

According to yet another aspect of the assembly, the predetermined material is 5083-H38 aluminum.

According to still another aspect of the assembly, the predetermined material is nickel based monel.

According to yet another aspect of the assembly, the predetermined material is TD nickel.

According to still another aspect of the assembly, the predetermined material is nickel based Hastlelloy B.

According to yet another aspect of the assembly, the predetermined material is nickel based Inconel X.

According to still another aspect of the assembly, the predetermined material is nickel based Inconel 718.

According to yet another aspect of the assembly, the predetermined material is nickel based Rene 41.

According to still another aspect of the assembly, the predetermined material is 5Al-2.5Sn—Ti ELI titanium.

According to yet another aspect of the assembly, the predetermined material is Ti45A [AMS 4902] titanium.

### BRIEF DESCRIPTION OF THE DRAWINGS

The structure, operation, and advantages of the present invention will become more apparent upon contemplation of the following description as viewed in conjunction with the accompanying drawings, wherein:

FIG. 1 represents a schematic illustration of an example tire and wheel assembly in accordance with the system of the present invention.

FIG. 2 represents a section taken through line 2-2 in FIG. 1.

FIG. 3 represents a section taken through line 3-3 in FIG. 2.

### DETAILED DESCRIPTION OF EXAMPLE EMBODIMENTS OF THE SYSTEM OF THE PRESENT INVENTION

A tire for use with the present invention and as described by U.S. Pat. Nos. 8,141,606 and 8,662,122, incorporated herein by reference in their entirety, may include an interlaced plurality of helical springs (i.e., coiled wires which deform elastically under load with little energy loss). The tire may define a toroidal shaped structure for mounting to a wheel. The tire may contour to a surface on which the tire engages to facilitate traction while mitigating vibration transmission to a corresponding vehicle. The helical springs support and/or distribute a load of a vehicle.

Under the weight of the vehicle, the tire may be driven, towed, or provide steering to the vehicle. The helical springs of the tire may passively contour to any terrain by flexing and moving with respect to each other. The interlaced structure of the helical springs provides stability to the tire and prevents the structure from collapsing as the tire rotates and engages variably terrain.

The helical springs of the tire may be resilient through a finite range of deformation, and thus a relatively rigid frame may be used to prevent excessive deformation. Radially oriented springs may be used to connect the tire to the wheel. These springs may be interlaced. Other springs may be incorporated with the tire at any bias angle, from radial to circumferential, with the purpose of distributing load. These other springs may be helical springs. Further, as one example, these other springs may extend circumferentially around the tire at a radially outer portion of the tire.

As one example, four basic steps may be utilized to manufacture one example tire: (i) twisting helical springs together to form a rectangular sheet with a length corresponding to the desired tire circumference; (ii) interlacing ends of the rectangular sheet of springs to form a mesh cylinder; (iii) collapsing one end of the mesh cylinder and attaching it to a rim of a wheel; and (iv) flipping the other end of the mesh cylinder inside out and attaching it to another axially opposite rim of the wheel.

The tire for use with the present invention may be utilized on Earth, the Moon, Mars, and/or any other planetary body, since its elements operate reliably in atmospheric and terrain conditions of these planets. The tire may be utilized on its own, or incorporated as a partial or auxiliary load support/distribution system within another tire type. The tire, however, requires no air, requires no rubber, operates in difficult environments, and contours to all terrains.

The tire provides an improvement over the conventional wire mesh tire of the Apollo LRV. The tire provides higher load capacity, since wire size of the helical springs may be increased with relatively little functional alteration. The tire provides a longer cycle life, since wire stresses of the helical springs are more uniformly distributed throughout the structure. Further, the tire provides relatively low weight per unit of vehicle weight supported, since the interlaced helical spring network is fundamentally stronger than a crimped wire mesh. Additionally, the tire provides improved manufacturability, since the helical springs may be screwed, or interwoven, into one another, rather than woven together. Furthermore, helical springs are able to compress and elongate to accommodate manufacturing variations. Finally, the tire provides improved design versatility, since load distribution springs may be added to vary the tire strength in different tire locations and directions.

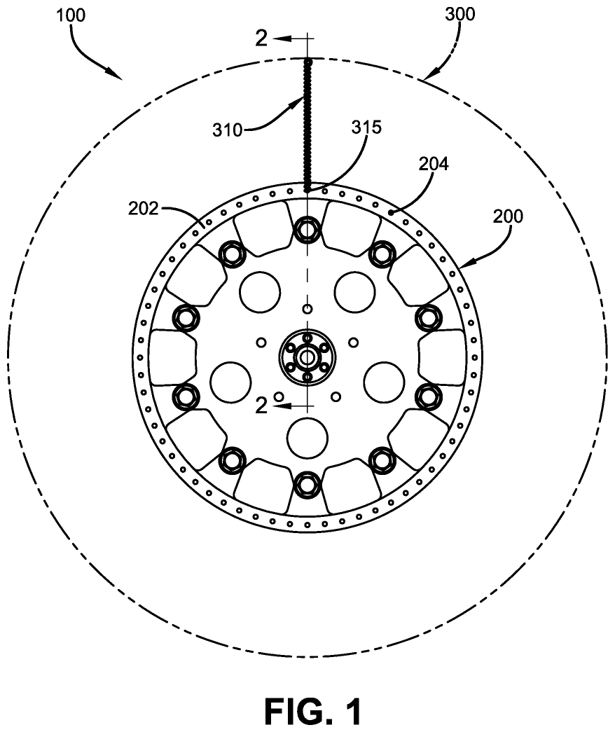

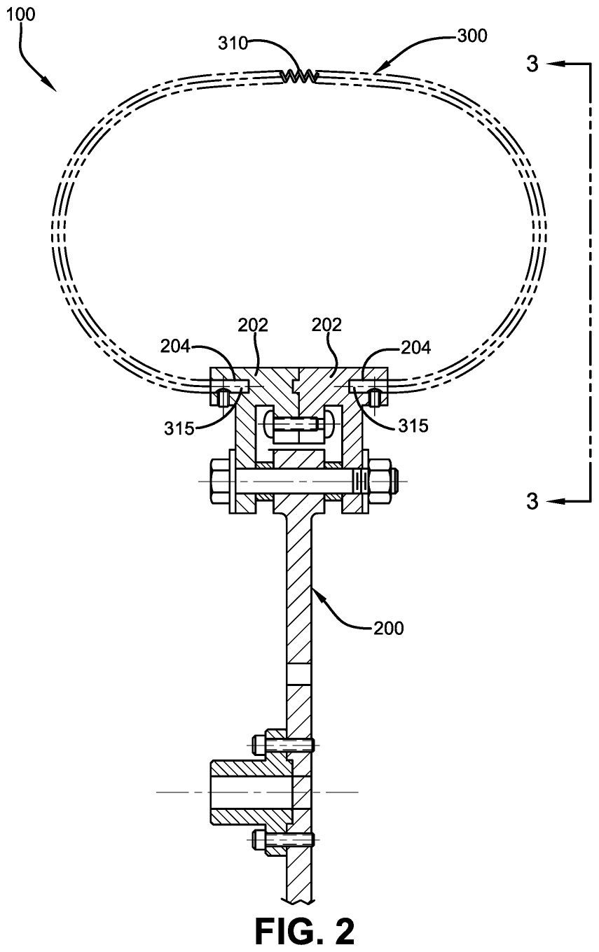

A tire for use with the present invention may thus be utilized where low vehicle energy consumption is required, where tire failure poses a critical threat, for traveling through rough terrain, where the vehicle is exposed to extreme high and low temperatures or high levels of radiation. As shown in FIGS. 1 through 3, an example assembly 100 in accordance with the present invention includes a wheel 200 and a tire 300. The wheel 200 has an annular rim 202 at each axial side for securing the tire 300 to the wheel. Each rim is fixed 202 relative to the other rim 202. Each rim 202 may include a plurality of socket holes 204 for aligning the tire 300 with the rim. Any other suitable means may be used for securing the tire 300 to the rim 200.

The tire 300 may include a plurality of helical springs 310 extending radially away from the wheel 200 in an arching configuration and radially back toward the wheel. Each end 315 of each spring 310 may be secured to wheel at a corresponding rim 202 of the wheel. Each spring 310 has a middle portion interconnecting the ends 315. Each end 315 may be secured at an axial orientation or at an angled orientation, with the spring 310 extending outward from one rim 202, then away from the wheel 300, then back over itself, then inward, and finally toward the other rim 202. Each end 315 of each spring may thereby be oriented coaxially (or at an angle) with the other end 315 of the same spring.

Further, each spring 310 may be interlaced with adjacent springs 310 enabling load sharing between springs. Each spring 310 is interlaced, or interwoven, with an adjacent spring 310 on a first side of the spring and further being interlaced with an adjacent spring 310 on a second opposite side of the spring. Thus, the springs 310 extend radially and axially and form a laced toroidal structure extending about an entire circumference of the tire 300 (FIGS. 1 through 3).

The helical springs 310 may be any suitable length, gauge, and pitch. The helical springs 310 may vary in coil diameter (i.e., barrel springs may be used) to create continuity in the mesh through the range of radial positions in the tire. The helical springs 310 may be further structured as two or more plies, one or more radially inner plies being radially overlapped by one or more radially outer plies.

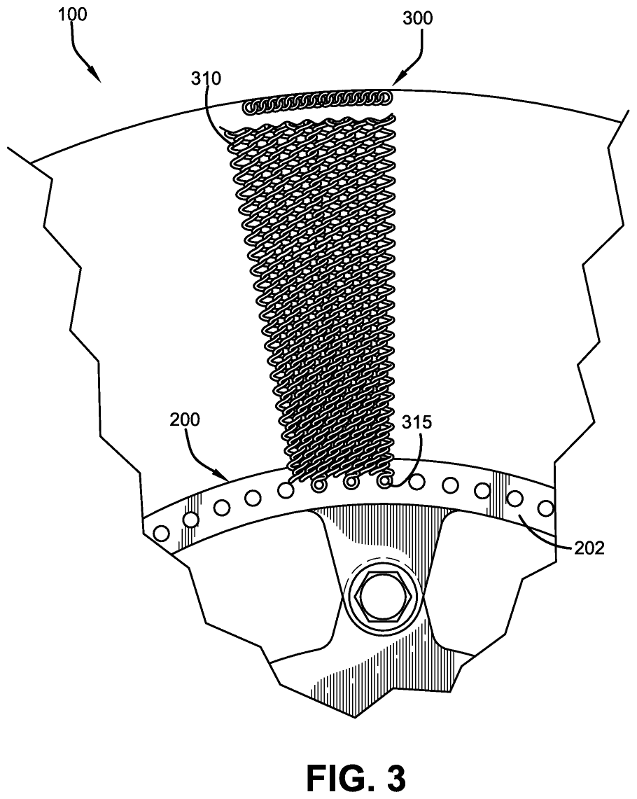

The purely metallic, conventional non-pneumatic spring tire 300 described above has been developed for space applications. The structure is a series of interwoven springs as seen in FIG. 3. This structure was well suited to space applications where rubber is not permitted due to temperature variations (40K to 400K). In addition, the spring tire 300 may achieve excellent traction where soil composition may be soft sand such as the Moon.

It has been found that permanently shadowed craters on the Moon may feature some of the lowest temperatures in the solar system—down to 20 K. Water ice may be stable at these temperatures, and it is believed that some of these craters harbor significant ice deposits. Consequently, according to the present invention, the spring tire 300 may be constructed of a material that retains its strength and ductility at temperatures as low as 17 K.

A conventional spring tire for the Moon has been constructed of materials which can survive and remain stable between 40 K and 400 K based on the then knowledge of the lunar temperature. As stated above, lunar temperatures may be as cold as 20K. Therefore, a new spring tire needs to be considered for lunar exploration to the permanent shadowed region of the lunar surface. Thus, a spring tire 300 with metallic alloys that would survive temperatures ranging from 17 K to 400 K is desirable. Ideally, such metallic alloys would function at extremely low cryogenic temperatures as low as 17 K and even down to 0 K.

One suitable material may be 304ELC stainless steel and/or 310 Low-C stainless steel. Such a material may maintain strength and ductility down to 17 K.

Another suitable material may be 2024-T4 aluminum, 6061-T6 aluminum, 2219-T87 aluminum, 5052-H38 aluminum, and/or 5083-H38 aluminum. Such a material may maintain strength and ductility down to 17 K.

Still another suitable material may be nickel based monel, TD Nickel, nickel based Hastlelloy B, nickel based Inconel X, nickel based Inconel 718, and/or nickel based Rene 41. Such a material may maintain strength and ductility down to 17 K.

Yet another suitable material may be 5Al-2.5Sn—Ti ELI titanium and/or Ti45A [AMS 4902] titanium. Such a material may maintain strength and ductility down to 17 K.

Still another suitable material may be Nickel-Based Inconel 600. Such a material may maintain strength and ductility down to 17 K.

Yet another suitable material may be multiphase Co-35Ni-20Mo-10Cr alloy MP35N. Such a material may maintain strength and ductility down to 17 K.

In the foregoing description, certain terms have been used for brevity, clearness, and understanding; but no unnecessary limitations are to be implied therefrom beyond the requirement of the prior art, because such terms are used for descriptive purposes and are intended to be broadly construed. Moreover, the description and illustration of the present invention is by way of example, and the scope of the present invention is not limited to the exact details shown or described.

Having now described the features, discoveries, and principles of the present invention, the manner in which the present invention is constructed and used, the characteristics of the construction, and the advantageous, new, and useful results obtained, the scope of the new and useful structures, devices, elements, arrangements, parts, and combinations are hereby set forth in the appended claims.

What is claimed:

1. An assembly having a wheel and a nonpneumatic tire, the nonpneumatic tire comprising a plurality of helical springs, each helical spring comprising:
a first end portion, a second end portion, and an arching middle portion, each helical spring being interlaced with at least one other helical spring thereby forming a laced toroidal structure extending about an entire circumference of the tire, the toroidal structure supporting an entire load placed on the nonpneumatic tire,
the first end portions of a plurality of helical springs being directly secured to a first annular structure of the wheel and the second end portions of the plurality of helical springs being directly secured to a second annular structure of the wheel, the first end portion of each of the plurality of helical springs being oriented coaxially with the second end portion of each of the plurality of helical springs,
the plurality of helical springs being constructed of a predetermined material that maintains strength and ductility down to 17 K.

2. The assembly as set forth in claim 1 wherein the predetermined material is 304ELC stainless steel.

3. The assembly as set forth in claim 1 wherein the predetermined material is 310 Low-C stainless steel.

4. The assembly as set forth in claim 1 wherein the predetermined material is 2024-T4 aluminum.

5. The assembly as set forth in claim 1 wherein the predetermined material is 6061-T6 aluminum.

6. The assembly as set forth in claim 1 wherein the predetermined material is 2219-T87 aluminum.

7. The assembly as set forth in claim 1 wherein the predetermined material is 5052-H38 aluminum.

8. The assembly as set forth in claim 1 wherein the predetermined material is 5083-H38 aluminum.

9. The assembly as set forth in claim 1 wherein the predetermined material is nickel based Monel.

10. The assembly as set forth in claim 1 wherein the predetermined material is TD Nickel.

11. The assembly as set forth in claim 1 wherein the predetermined material is nickel based Hastlelloy B.

12. The assembly as set forth in claim 1 wherein the predetermined material is nickel based Inconel X.

13. The assembly as set forth in claim 1 wherein the predetermined material is nickel based Inconel 718.

14. The assembly as set forth in claim 1 wherein the predetermined material is nickel based Rene 41.

15. The assembly as set forth in claim 1 wherein the predetermined material is 5Al-2.5Sn—Ti ELI titanium.

16. The assembly as set forth in claim 1 wherein the predetermined material is Ti45A [AMS 4902] titanium.
